(19) United States
(12) Patent Application Publication
(10) Pub. No.: US 2025/0150259 A1
(43) Pub. Date: May 8, 2025

(54) ENCRYPTION SYSTEM AND METHOD

(71) Applicants: Paul Westmeyer, Lancaster, PA (US); Renee Mazaheri, Lancaster, PA (US); Russell F. Wertenberg, Belmont, CA (US); Robert Edwin Woods, III, Stafford, VA (US); Robert Parker Woods, Stafford, VA (US)

(72) Inventors: Paul Westmeyer, Lancaster, PA (US); Renee Mazaheri, Lancaster, PA (US); Russell F. Wertenberg, Belmont, CA (US); Robert Edwin Woods, III, Stafford, VA (US); Robert Parker Woods, Stafford, VA (US)

(21) Appl. No.: 18/837,917

(22) PCT Filed: Feb. 15, 2023
(86) PCT No.: PCT/US2023/013090

§ 371 Date: Aug. 13, 2024

Related U.S. Application Data
(60) Provisional application No. 63/311,023, filed on Feb. 16, 2022.
(60) Provisional application No. 63/433,854, filed on Dec. 20, 2022.

(51) Int. Cl. H04L 9/08; H04L 9/40

(52) U.S. Cl. CPC H04L 9/0825; H04L 9/0894; H04L 63/0236

(57) ABSTRACT

Augmenting provides for networks of computers, operating on connection channels including the Internet and with-in Intranets, specifically designed to: host data and code without detection, and share encrypted messages, including messages with encryption algorithms and keys embedded within, without concern for public interception of the transmission. Without concern for detection or interception users can generate new algorithms and keys as often as they want. The augmentations include computers, dubbed “shadow computers,” within the design which are known by not accessible except from “White Listed” and other authentication technique paired companions.

### CROSS REFERENCE TO RELATED APPLICATION

The present application is based upon and claims the benefit of U.S. provisional patent application No. 63/311,023, filed on Feb. 16, 2022, and U.S. provisional patent application No. 63/433,854, filed on Dec. 20, 2022, which are incorporated herein by reference in their entirety.

### TECHNICAL FIELD

This invention relates to Systems and Methods designed to Protect Encryption Algorithms and Associated Keys, and the user data protected by these algorithms and keys. The system and methods also are designed to provide Augmented or Enhanced Encryption when needed. Unique data encryption of Data in Motion between nodes of the Augmented Protection and Encryption System (APES) protects the data from being unencrypted if collected from the Internet transmission system by an unintended user, and encrypted Data-at-Rest (DAR) within APES Systems' nodes memories are protected due to the inaccessibility of some APES computers.

Augmented Protection and Encryption System (APES) creates networks of computers, operating on the Internet and within Intranets, specifically designed to host data and code without detection, and share encrypted messages, including messages with encryption algorithms and keys embedded within, without concern for public interception of the transmission. APES include computers, dubbed “Shadow Computers (SC),” within the Internet-of-Things (IoT) which are known but not accessible except from APES defined companion SC, restrictions controlled by APES' “Invisible Computers” (IC) create companions for SC. These IC are defined in U.S. Pat. No. 10,419,131 as the ‘second device.’ SC are not the ‘first device’ of U.S. Pat. No. 10,419,131. APES' “Known Computers” (KC) are the first device of U.S. Pat. No. 10,419,131. Companions, pairs or clusters of SC, are isolated between APES' IC, wherein the access restrictions are applied.

IC create accessibility restrictions for SC, from the IoT, creating an environment for deployment of novel encryption/decryption capabilities. Companions are assured their messages are controlled at the sender and receiver ends of a communication, and are assumed to be uncontrolled within the rest of the loT domain including the APES KC and all connections between the APES KC and Internet Service Providers (ISPs). Encryption and decryption are done inside the SC.

Supercomputers and Quantum Computers with Artificial Intelligence (AI) will be denied ongoing connections normally associated with using recurring encryption of a specific algorithm and keys, effectively denying nefarious access and data collection that could enable decoding or learning.

User defined specific encryption algorithms or keys are enabled, APES' SC host algorithms and keys. APES devices are capable of hosting many discrete encryption strategies or processes, users can also define their private algorithms and/or keys (new algorithms and keys). Creative minds can generate single or multi-dimensional algorithms and keys using existing schemes, adapting existing schemes, combining old and new schemes, including One-Time techniques mostly ignored as too cumbersome but enabled by database tools to create unique/personalized encryption strategies and processes. APES hosts of encryption tools, especially massive database structures, has few limitations as memory and processing capabilities of computers have grown substantially in the last few decades. APES' SC can perform this as a singular primary function, encryption/decryption and can be dedicated to just that set of operations, leaving all data operations related to the files to other protected user systems or APES' SC's can perform additional deep packet inspection. APES' SC's are systems of systems so that subcomponents of APES' SC's and IC's can contain additional IC protections for subcomponents like media storage.

ISP can provide additional independent security measures on files provided by APES. Legal requirements to remove ISP security measures, such as court orders, will not undo APES unique private encryption. APES encryption occurs before engagement with the ISP.

### BACKGROUND OF THE INVENTION

The IoT has grown substantially. Encryption is touted as a means to secure data. Yet encryption keys are stolen and used. Corrupting the encryption/decryption algorithm is yet another concern; if the computer is hackable, then all associated processes are potentially alterable or under the control of a nefarious actor or organization. Key theft enables an attacker to decrypt messages, and algorithm changes can potentially be applied to deny the user any encryption or decryption option. Compounding these concerns is Quantum Computing with Artificial Intelligence being potentially capable of breaking current encryption by brute force or more elegant knowledge, rules, or artificial intelligence, based attacks. Increasing the key size has been a successful strategy to defeat ever increasing performance of conventional computing, but creative use of Quantum Computing is predicted to overwhelm any key size increases. A new strategy, beyond key size increases, is being investigated to address the risk Quantum Computing brings to encryption processes.

Many specialized computer functions have been targeted by nefarious actors. Protecting those computers has to be a priority before addressing the purpose of the computers' actions. U.S. Pat. No. 10,419,131 teaches computer isolation and protection, isolating some computers from discovery by eliminating those addresses from the easily accessible directory of known used Internet Protocol (IP) addresses. These discoverable computers, the ‘IC’ in this application, become data flow governors for the discoverable but restricted access SC.

The world is in need of a new way to secure data, whether that data be on a private network, or transiting and/or stored on public networks and systems. Numerous data-centric activities under computer controls need to be protected, especially when the data are subsequently detectable and collectable on public infrastructure; public storage (“the cloud”), communications, and routing being the obvious places where data could be nefariously collected without the awareness of the sender/receiver. Cloud Services Providers can host individual or multiple IC protected SC's as companions for specific users with IC's controlled from on premises or through off premises (remote) special communications connections.

### BRIEF SUMMARY OF THE INVENTION

This invention relates to an encryption/decryption system and method for securing data in motion between two or more computer systems; Augmented Protection and Encryption System (APES). The degree of the computers' IP addresses being IoT knowable and accessible defines which category, KC or SC or IC, each APES computer is in. Implementation at different locations within the IoT will allow for security of all APES protected traffic on the IoT. Encryption/decryption algorithms and keys reside in SC. The protection from IoT access to the known restricted access computers (SC) is defined by rules residing in adjacent unknown undiscoverable computers (IC). IC at each location provide decision-making about allowing or not allowing connectivity between the known restricted access computers (SC) in the different APES, and prohibiting all non-APES connectivity. These adjacent computers are not known to the Internet and are not accessible from any nodes on the Internet, making these not accessible computers effectively invisible. The secure data occurs as encryption processes, algorithms, and encryption keys are applied to data in motion, encryption processes, algorithms and encryption keys hosted to known computers with the APES.

In another embodiment, an encryption system and method comprising at least two devices communicating with an infrastructure of the IoT, not all of the computers within said at least two devices are accessible from the IoT, a first device having some components within the IoT, communicating via the IoT infrastructure, with a second device having some components within the IoT. Said first and second devices each have at least one IoT known and not accessible internal computer, and are exclusively accessible (White-listed and other authentication techniques) to each other. Additional devices' computers define the exclusively accessible (White-listed and other authentication techniques), said additional computers are invisible to the IoT.

Data at Rest (DAR) are protected within any APES protected computers if the data are stored using APES encryption which may also be different than the SC encryption.

### BRIEF SUMMARY OF DRAWINGS

FIG. 1 shows a 3-Modules Block Diagram of the system of this invention.

FIG. 2 shows a 5-Modules Block Diagram of the system of this invention.

FIG. 3 shows a 7-Modules Block Diagram of the system of this invention.

FIG. 4 shows the 5-Modules Block Diagram of FIG. 2 in greater detail.

FIG. 5 shows the 5-Modules Block Diagram of FIG. 4 in even greater detail.

### DETAILED DESCRIPTION OF THE INVENTION

Enabling dynamic encryption can be accomplished with augmentations to U.S. Patent 10,419,131. The augmentations create more isolatable discoverable modules by expanding from 3-Modules designs to larger numbers of modules wherein each newly added discoverable module is bracketed by non-discoverable modules (second devices from U.S. Pat. No. 10,419,131). Modules can be a single computer or a suite of computers. This is accomplished by adding two modules, one non-discoverable module and one discoverable module, to whatever configuration was the starting configuration (3 to 5, or 5 to 7, etc.). White-List, restrictive connectivity, isolate computers within the discoverable module(s) bracketed by non-discoverable modules, and greatly expand the rate of algorithms and key replacements for encryption hosted on White-List (and other authentication techniques) isolated computers. A new descriptor is required for designs using 5 or more modules, as compared to the 3 modules designs of U.S. Pat. No. 10,419,131. In the previous designs using two devices, as defined in U.S. Pat. No. 10,419,131, the user computer was being protected from hacking using restrictive listing. APES adds new functionality; encryption/decryption for Data at Rest and Data in Motion, even when the data are outside the user's domain, such as residing within the IoT domain.

Three descriptors are used in this application. Descriptor for IoT accessible computers is KC (previously defined as ‘First Device’ in U.S. Pat. No. 10,419,131). Descriptor for IoT known but restricted access computers is SC. Descriptor of computers not known to the IoT are IC (defined as ‘Second Device’ in U.S. Pat. No. 10,419,131.). SCs will pair with other SCs, also called companions.

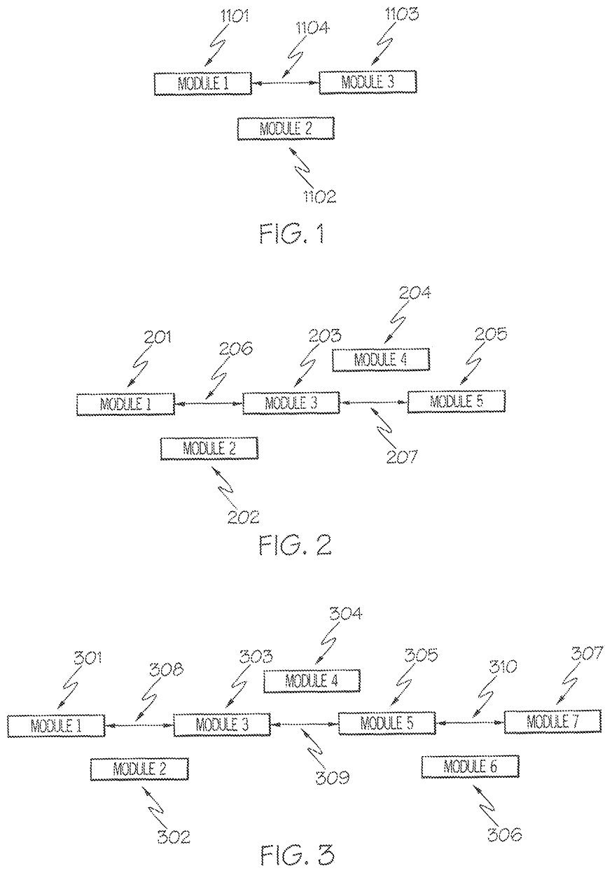

Invisible computers, one or more computers, define a specific Communications Controller Module, establishing the delineation of modules. FIGS. 2 and 3 show a linear transport using bidirectional arrows between the odd-numbered modules. Also shown are the even-numbered modules with data flow control arrows reflecting their control over the bidirectional transport arrows. Even numbered modules operate on limited data, the headers of packets. If the header data is matched to an allowed/authorized IP address and header authorization techniques then access is approved. Approved access is accomplished by the even-numbered modules gating the data between adjacent odd-numbered modules.

By example: IoT data packets arrive in Module 1, the header is read by KC in module 1, header data is securely shared with IC of module 2. If IC in module 2 defines the header IP address as an unwanted IP address, module 2 denies transport of data packets to module 3, and all packets associated with that IP address are filtered out by Module 1. Conversely, if IC of module 2 determines the header data are from another APES system, module 2 approves transport of data packets to module 3, and all packets associated with that header authentication are approved for transfer from Module 1 to module 3. APES data packets are encrypted and the inspection tools of Module 1 will be unable to decode any content in the packet data fields. After a completed data packet inspection (more than encryption tests can be accomplished) in module 1, a flag is enabled and sent to module 2, and module 2 activates the data transport from module 1 to module 3. These packets are flowed into Module 3, specifically to a SC companion to the source SC, decryption occurs in module 3 and the unencrypted data are inspected, assuming nothing nefarious is detected then data flows deeper into the systems. A third scenario is also possible, Module 2 determines the unencrypted headers are from some system of the IoT, not from an unwanted IP address. Module 1 will exercise tools, including any decryption by public/private keys, to check for nefarious intent. Module 2 determines the data are safe to transport into module 3, however, there are additional conditions to be satisfied. The first condition is that module 3 has a non-shadow computer compatible with IoT addresses. Provided a module 3 non-shadow computer is selected then the module 3 data packet evaluations (similar to module 1 evaluations) will occur. Module 3's non-shadow computer's deep packet inspections, and other tools, will be used to assure no nefarious intent. If a module 3 non-shadow computer is not available then the APES module 1 will not receive a valid transport authorization from module 2's IC, the data file is filtered out by module 1. There is yet another scenario, hackers have fooled the module 2 with a stolen shadow computer header, upon completion of inspection at module 1 the data are transported into module 3, to an SC, where the decryption will fail! Module 3 will filter out the data, these packets never get to the user system.

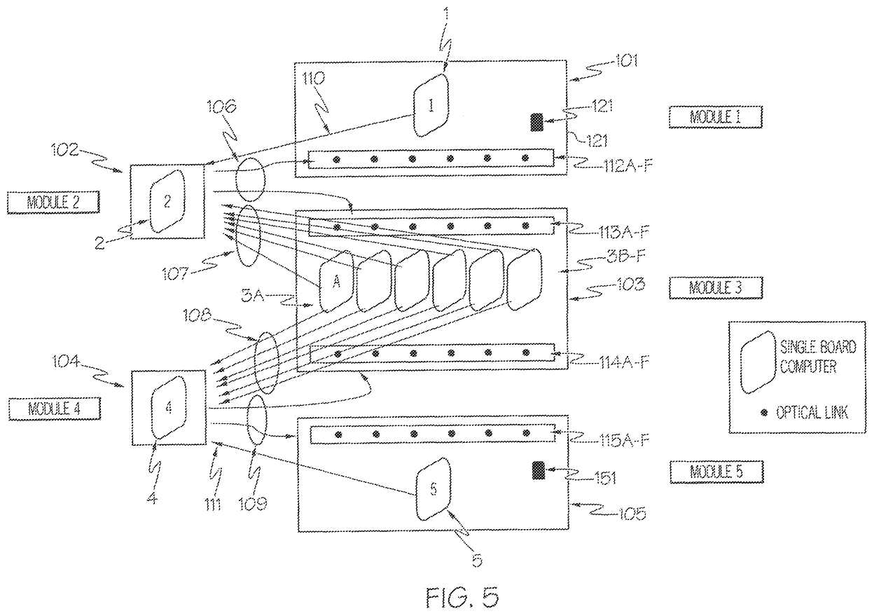

The obvious nature of any middle module is defined; either a middle module is APES-exclusive or the middle module includes at least one computer that is not a SC. FIG. 5 has a single computer, labeled as ‘A’, in module 3 that is different from the other computers which are all SC. If FIG. 5's module 3 computer labeled ‘A’ is not an SC, reflecting a version of a middle module with a non-SC computer, then conventional IoT communications can occur. If that ‘A’ computer in FIG. 5's module 3 is an APES' computer, like all the rest of the SC in module 3 of FIG. 5, then only ‘A’ companions would be authorized to communicate with ‘A’. If FIG. 5's module 3 has only SC then FIG. 5 would reflect an APES-only device.

FIG. 5 shows additional data communications between odd-numbered and even numbered modules. For data flowing into APES from the Internet the data flow are on data line item 110 of FIG. 5; sending non-packet data from KC ‘1’ to IC ‘2’. If the packet data is passed along from module 1 to module 3 then non-packet data is shared between a computer in module 3 and IC ‘4’, using a data line in bundle item 108.

Two versions of APES's exist, defined by the odd-numbered middle modules; one version of APES has only shadow computers and as such the non-SC/non-companion sourced data from the IoT is blocked. The other version of APES has non-shadow computer(s) and can process IoT data originating from sources other than companions. FIG. 3 reflects a 7 modules configuration. It is possible module 3 and module 5 are deliberately configured to block all IoT communications, it is also possible that only one of the odd-numbered middle modules (3 or 5) are configured to block IoT communications. In either case the IoT would be blocked.

The practical utility of having 7 modules configured with incompatible IoT modules, a module 3 being IoT capable and module 5 not being IoT capable, is to inform the APES Intranet of attempt to infiltrate an APES Intranet configuration.

APES augmentations will allow users secure access to new encryption processes, algorithms, and keys over the Internet as companion computers communicate using one-time scripts of unknown keys applied to an equally unknown algorithms (plurals of keys and algorithms applied to a single message). Users can change processes, algorithms and keys as often as they want, making decoding by persons other than the intended audience nearly, if not completely, impossible. Process, algorithm, and key transfer messages should use multiple keys and multiple algorithms, and this combination of algorithms and keys can be mixed and matched or discarded with respect to future messages. Mathematically there are an infinite number of multivariable polynomial expressions to be algorithms, and keys can be big or small or both. When a user-defined process requires algorithms are morphed within a single packet or message, and different keys are applied as well, the overall potential for any random decoding is effectively zero.

Expanding the range of algorithms, and shifting their usage, coupled with an equally diverse key structure, on SC secured behind IC, has profound consequences to decryption. When a receipting computer has zero insight into how the encryption was done (e.g., process, algorithm(s) and key(s)) the chances of randomly being able to decrypt any message or portion of a message approaches zero.

The OVRWatch™ system is a commercialization of U.S. Pat. No. 10,419,131; a multi-modules hardware-software design. The simplest version of OVRWatch™ system has three modules. Module one's hardware and software are part of the Internet, permanently connected to the Internet, module one hosts additional customized software. The “second device” of U.S. Pat. No. 10,419,131 is incorporated into OVRWatch™ Module two, also hosting additional customized software. OVRWatch™ module three hosts the hardware and software functionality of “first device” of U.S. Pat. No. 10,419,131, plus customized software. Customized software tools include, but not limited to, classic “firewall-like” and “Intrusion detection like” checks in modules one and three.

Proprietary software, including firewalls, are offered as part of OVRWatch™ system, but any user defined firewall, or other tools are also accommodated. These accommodations extend to NIST (or any other organization establishing guidance and/or standards) approved solutions for advances in encryption/decryption as well.

Augmentations include expansion of the 3-modules OVRWatch™, shown in FIG. 1, to five modules as shown in FIGS. 2 by adding one discoverable module and one non-discoverable module to the FIG. 1 configuration, and to seven modules as shown in FIGS. 3 by adding one discoverable module and non-discoverable module to the FIG. 2 configuration. The utility of building more than nine (9) or eleven (11) modules versions is decreasing because of the complexity inherent in compounding devices. However, for truly risk adverse situations the higher modules configurations (9,11,13, etc. . . . ) allow complex internal routing of data within the SC; branching operations can be deployed. Linear process flows, as shown in FIGS. 2 and 3, are typical. Non-linear loops would be possible creating multi-pass encryption and even transfer from one APES at a location to a second non-disclosed APES at the same location for additional processing.

As noted earlier the APES can be made to reject all non-APES connectivity, and cascading APES has a profound consequence, the Internet facing APES could accept IoT data while a second APES, closer to the user systems, could be configured to only accept APES companion data. In effect the Internet sources would have a response that seems to reflect access to the users' systems, when in truth the second APES blocked all of the IoT sourced data except from the known companions'.

Encryption will reside on computers in the odd-numbered modules bracketed by even-numbered modules, module three in the 5-Modules configuration, and modules three and five in the 7-Modules configurations.

Module numbering is defined by proximity to the computer being protected, lower numbers are farther from the computer being protected. In the 5-Modules configuration the “middle” module's (number three) computers are known, potentially accessible, potentially not accessible due to connectivity restriction (White-Listing and other authentication techniques) imposed by modules two and four.

FIG. 5 shows a single accessible computer, letter ‘A’, in module 3; satisfying a ‘potentially accessible’ version. In this version of APES nominal IoT traffic moves through module 3 computer ‘A’.

Likewise, if no module 3 computers are IoT accessible then the user has access only to companion connections over the IoT.

All the computers in even-numbered modules are undiscoverable, as defined in U.S. Pat. No. 10,419,131.

Functional actions, embedded in computers in odd-numbered modules, include filtering and packet inspection and other techniques to discover nefarious content.

The lowest number module in any configuration (module one in the 3-Module, and module one on the 5-Module, etc.) perform identical functions. Likewise, the highest numbered module of each configuration (module three in the 3-Module, and module five in the 5-Module) performs the identical functions. The significant difference of modular functionality occurs in the odd-numbered isolatable “middle” module(s); module three of the 5-Module, and modules three and five of the 7-Module, etc.

Computers, in middle modules, performing encryption/decryption functions have highly restricted White-List and authentication access. Excluding unwanted communication channel traffic (IP addresses and other protocol traffic), commonly referred to as “Black-Listing,” is a core capability of OVRWatch™ systems. Conversely, “White-listed and other authentication technique” communication channels traffic (IP addresses and other channel traffic) are from known, trusted, sources. Other techniques include authenticated computers, IP and MAC devices. Module one performs the external interface functionalities including but not limited to, source and routing checks, packet inspections tools (always being updated), and any other tools deemed necessary or desired. Likewise, the highest numbered module will perform functionalities similar to module one, plus secure the protected system's input/output ports. These actions are the basic odd-numbered (e.g., 3, 5, 7, 9, . . . ) Module systems requirements as implemented. In a layered defense where multiple OVRWatch™ are deployed, the protected system's input/output ports should only be addressed by the OVRWatch™ closest to the protected system.

Even-numbered modules are “gate keepers,” controlling the momentary connectivity between the adjacent odd-numbered modules. IoT connectivity is only continuous for module 1, all higher-level odd-numbered modules achieve connectivity to the closest lower numbered odd-numbered module when the adjacent even numbered module authorizes data connection; for example module 5 is only connected to module 3 when authorized by module 4.

Rules within the even-numbered modules are simple compared to the data inspection rules of the odd-numbered modules. Automated tools for high throughput systems can have header data being inspected by even-numbered modules, but these are comparison checks with White-List and authentication techniques, and maybe Black-List depending upon the customer defined requirements.

In a simple strategy within a middle module (3 of 5 for example) a single SC is used for encryption-decryption actions and a different SC is used to host the encryption algorithms and/or keys; an SC is always required for algorithm and/or key management. A more complex strategy will separate the pathways for encryption and decryption, using two SCs for action. Far more complex strategies are possible, including separate SC for different communities of users. For example, financial records are managed by a different shadow computer from medical records, and yet another has personnel files. Each community of users will define their unique sub-communities. Persons skilled in computers and computing systems architectures will find the various exemplars sufficient to create many architectures from any number of components. While terminology will vary, the framework is common enough to allow for customization.

Another use of a shadow computer can be to separate out file types; voice from data, or even higher filtering of voice sources from each other using different encryption to prevent an entire conversation from being compromised if one end of the conversation is captured as clear and encrypted.

Installing changeable algorithms and keys on any shadow computer can be accomplished using the Internet or in person by a systems administrator to safely distribute those algorithms and keys utilizing a previously installed algorithm and key that should (“shall” for the most risk avoidance) never be used again as an infinite number of algorithms and keys are now shareable. A new strategy for managing both keys (traditional actions) and algorithms will be incurred.

These designated SC are known to the Internet (IP address exists). But these SC are not accessible except by other known SC (aka companions), their functionality can be highly specific to one or more purposes, such as encryption algorithms and keys controls; other purposes can be added. When any IP address (external or internal) attempts to connect to any shadow computer that request will be filtered by the controlling non-accessible even-numbered computers regulating the optical links. Optical links will be enabled by the even-numbered modules and data will transfer between the odd-numbered module adjacent to the odd-numbered module hosting a shadow computer if the Internet or Intranet node making the request is on the access list (White-List and other authorization techniques) for the shadow computer. White-List and/or other authorization techniques reside in the even-numbered modules (modules 2 and 4 in a 5-Modules version of OVRWatch™).

The third and fifth modules are center modules in a 7-Modules version of OVRWatch™ system. Controlling the data flows into and out of the 7-Modules' SC are modules two, four, and six. With multiple modules hosting SC a vast new strategy opens up to users. Complex encryption/decryption can be employed, in effect a multiple-pass or multi-dimensional system can be developed, data could be processed in module three then module five, and even back to module three, etc.

With even-numbered modules controlling the communication channels (IP address' and other) for the center module(s) there are simple techniques to authorize including White-Listing to prevent any unwanted access to those central module IP addresses. Because the even-numbered modules' IP addresses are not accessible they are immune to attacks, alterations, etc., thus the perfect guardian of a pairing protocol between center modules located within the vastness of the Internet. By example, if two 5-Modules devices are a “center modules pair,” and are located hundreds of miles apart, and using communication paths including the Internet to carry messages, then an authenticated (including White-Listed) paired partner located within their respective modules 2 will allow them to accept messages from their paired partner and no other (non-authenticated/paired) device.

What algorithms and keys are installed in any shadow computer is user defined. A Systems Manager should be the human controlling the process. Thus at least one of the SC has an additional interface to allow for direct, discrete, and well-defined human interactions. Added security measures might be applicable to remove risk of the human being compromised. Those added security features are also user-controlled, and not part of this application other than to note there are means to provide security for the human interaction with systems hosting SC.

There is an autonomous version of algorithm and key development that can rely upon inputs from individuals' actions in response to a system query. An automated query can seek inputs from users and the order and content of the modes' responses can become a seed generator. One seed generator scheme would cause a series of files to shuffle their contents generating new polynomials for algorithm definition, and likewise a secondary seed could generate new keys, shuffling an array of random number generated in association with the algorithms. Algorithms and keys can be other constructs, polynomials are just one approach.

In another autonomous version of algorithm and key development a reset value can reorder controlled files, large arrays of numbers. These large arrays are seeds to algorithms and keys, similar to the above-mentioned “individuals' actions in response to a query.” Hundreds to thousands or tens of thousands of values can be shuffled in several SC' memories, and shared using still active algorithms and keys.

Encrypted messages from seemingly authentic sources, including a White-listed IP address, would not have the required, but unknow to nefarious actors, characteristics to spoof packet headers and traffic. Several operational controls can be added to subject critical messages, such as a new encryption algorithm load, to internally known restrictions; an easy example is a time stamp window. In some domains this is called a “Command Access Period” (CAP). If the spoofing falls outside the acceptable allotted time stamp window then the whole message is deleted. Another operational control can be multiple messages from multiple IP address are required (similar to multi-factor authentication). Many more controls can be installed to safeguard the options for uploading a new algorithm (or key system). All of these concepts are commonplace in routine security systems.

One clear solution to Quantum Computing and Al is to constantly change the algorithms and keys, but this poses a new threat, confusion when algorithm and key management fails.

Balancing these competing challenges is a business decision, risk vs. cost. Building a process within a computer to generate encryption codes is not new, as noted in the references to U.S. Pat. Nos. 5,614,900 and 10,917,403. Blowfish encryption was written in the 1990s. Other products and algorithms have been declared including the Skipjack algorithm used in U.S. chip manufacturing.

Without a specific user requirement, it is impossible to define the exact encryption and key models any users will deploy. Suffice it to say the “experts” in these matters will deploy the tool they feel best services the community of users based on risk-reward analysis. The architecture of the SC, with White-List and other authentication protections, enables a whole arena of opportunities for encryption experts.

Less obvious filtering will become commercially interesting as content can be filtered, or prevented from being filtered, by software. Content filtering might remove sales and/or advertisements that the user wants to ignore.

APES devices can be integrated into electronics or an after-market augmentation.

APES reflects a system capable of accepting existing and custom tools for encryption including using database concepts. An integral aspect of any database is the means to track changes and maintain controls over the database systems, with a robust recovery in the event of a system fault.

By example, if we define a two-dimensional array of 10,000 by 3 elements database, in support of a one variable polynomial expression where the coefficient terms (A, B, C) for the second-order polynomial are hosted (Ax²+Bx+C) and establish the database version to be number 628, with a starting pointer location of 8,197, and an array transition every 18,000 bits then we can place those three values (628, and 8,197, and 18,000) into a header and provide all the necessary decryption parameters. Additional header data could include the date of the parameter selections, the location of the parameter section, etc.

Changes in encryption, after 18,000 unencrypted bits, causes the pointer for the database to move from position 8,197 to 8,198 causing three new coefficients to be used for the polynomial parameters of ‘A’, ‘B’, and ‘C’. This process continues, moving the pointer and acquiring new coefficients until no new unencrypted bits are available for encryption. It is equally interesting to select values in the header (628, 8,197, and 18,000) with their own offsets; 628 could actually mean 286 or 826, and similarly 8,197 could be 1,879 using the numbers but in some slightly different order. The header bits can have flag set within them to assist in keying in the correct meanings.

One packetization scheme for encrypted bits is to hold the encrypted contents in a buffer, concatenate them, to form new packets.

The version number, 628, can be updated at some periodicity, altering the database contents. When updated, the version shuffles the 10,000 by 3 elements database content. New data can also be included, replacing some old content with different content previously not used.

Another version of the database can be hosting different mathematical expressions, rather than a database of 10,000 by 3 elements the database could be 15,000 by 11 elements allowing for more complexity in the polynomial including multiple variables, etc. With a few bytes of header data many different encryption strategies can be deployed by a user. Likewise, the dimensional nature of the database can be larger, three-dimensional or even more than three-dimensional. Which dimensions get used can be selectable. Database management tools allow these and other constructs.

Another packetization scheme for encrypted bits is to hold the encrypted contents in a temporary buffer, concatenate them, to form new packets. Another scheme is to encrypt a packet, fill the unused portion of the new defined packets, assuming the original single packet is expanded to be more than a single packet, and concatenate the encrypted packets.

The version number can be updated at some periodicity, this would be consistent with a ‘shuffle’ or ‘replacement’ of the database contents.

In another construct the databases of algorithms and databases of keys are separated and hosted on different Shadow Computers.

Another construct permits the algorithm and key transitions to be asynchronous, and even more complexity could be achieved if the asynchronous transitions are of unequal bit quantities; algorithms could be changed for every 1000 bytes of unencrypted data whereas the keys are changed at an interval other than 1000 bytes.

The mathematics underpinning the encryption can be from a vast array of fields including classic mathematics to linguistics to images to icons to music or anything that can comprise a set.

Algebra, trigonometry, topology, complex variable, and many other fields of mathematics can be considered. As can use of other icons, colors, images, sounds, and known or created languages. Large database management tools are routinely used to build large arrays, with multi-dimensional content. There are parameters in the processes of encryption that can be reset, reused, skipped, and/or shifted in the database, etc., making it impractical to attempt to discover the means of encryption, even as copies of data are captured by unauthorized collections while the data are in transit on public infrastructure communications systems.

All of these strategies have limitations, but practically speaking the options are only limited by the available bits in the messages. Complex messages can be expansive or compressive. Normally, encryption generates more bits (expansive) than the original message, but complex symbols can host more data (compression). By example, classic fiber optic carriers use many photons (thousand to millions) to transmit a single bit. However, in a novel carrier strategy of defining the timing between any two photons as the data word a massive compression occurs. This is the NASA Interplanetary Communications baseline. Similarly, language experts have many examples of pictures as words or stories (massive compression).

In a closed system SC, any number of advances in data compression are practical. Whole new structures can be employed as the user community is restricted.

File management is critical to all these encryption strategies. A default file is a necessary reset when any messages fail to decrypt. Building a robust files support system has been a mainstay of database designs for decades. Tools to define and repair unintended mistakes within a database are commonplace. Somewhere in the user's domain of SC the user will need to install their toolsets.

FIG. 3 the middle modules, number 3 and number 5, are linearly routing; meaning external data flows into the protected system following a series of steps, from module 1 to module 3 to module 5 and finally to module 7. Linear could be disrupted by special routes wherein connectivity patterns are akin to classic hydrocarbon molecule chains allowing branches off the main sequence. Such a branching could create complex pathways especially when larger numbers of SC are employed.

Branching is especially useful when a module is the last in a series allowing IoT interfaces (a non-SC exist in the module). For the previous logic wherein a mismatch of SC was deliberately installed, and the non-SC data routing can be moved ‘out-of-linear-processing’ and into a processing system designed to analyze potential nefarious intent. In this scenario module 3 has an IoT accessible computer, and module 5 does NOT have an IoT accessible computer, those data in module 3's IoT accessible computer can be routed out of the linear processing into a separate node.

In yet another mode the ‘out-of-linear-processing’ night be to repeat processing steps, doubly encrypt for example.

Optical connectivity controls can be used to selectively define unique routing based upon header data and authentication techniques. Such routing can generate a means to ‘dead end’ a series of packets when a nefarious actor is to perform a data exfiltration (steal data from a protected system). Likewise external packets could be routed to a computer acting as a ‘honey pot’ with either a defensive non-response or an offensive response to the external source.

Optical routing can also mean communication channels traffic including a header generates multiple receivers; just as the Internet can and does provide multiple routes for packets the APES can mimic that feature.

Layering these encryption capable modules, such as a cascade of multiple 5-modules, has a complex consequence of layers of encryption.

Users operating at different levels of security may insert a unique SC for each unique level of security. Consider a corporation wherein the senior management has communications with many subgroups that have significantly different purposes, accounting, legal, marketing, etc., there could be justification (e.g., corporate policy or governmental regulation) to isolate these subgroups interfaces at the senior manager level.

Rather than creating security in a few complex algorithms the complexity of this application occurs because of the sheer number of algorithms, thousands to billions depending upon the users' requirements. Likewise, keys are expanded to vast numbers, rather than larger number of bits in a single key. In One-time-pad (OTP) operations these two large arrays, in databases under the encryption/decryption computers' control, combine to be impossible or nearly impossible to crack. Unlike a current encryption/decryption strategy where a crack opens the door to decode many messages the successful crack of a single OTP message, or part of an OTP message if the user wants to break messages into smaller segments, discloses nothing about other messages except that the cracked code is not an option for decoding additional messages.

Management of these arrays of algorithms and keys is also a more manageable task with modern computers and associated messages. With memories being expandable to gigabytes on a single board computer and database systems being commonplace, the concept of large managed databases is an obvious candidate for generating algorithms and keys, by the billions. Advanced multi-dimensional mathematical systems can be different for different users, thus a nefarious collector has more than simple prime number factoring to consider. How any particular user defines his database entries is an option exclusively for the user. The multi-dimensional aspects could be applied to the processes, algorithms, or keys in any combination. Hosting a client's private processes, algorithms and keys, and process, algorithm, and key management tools, and means to facilitate coordination of updating the process, algorithms, and keys, and other relevant tools, is all contained in the SC. The potential for filtering out all executable code can be done successfully through this process.

As connections are allowed, or not allowed, a pattern of Internet versus Intranet emerges. What distinguishes the Internet from the Intranet are the connection rules.

Within a message secured by any of the mathematics is yet another aspect of a 5-Modules unit, the messages are useful in generating and distributing more algorithms and keys, over the Internet, as an Intranet.

### DETAILED DESCRIPTIONS OF THE FIGURES

FIG. 1 shows a block diagram of a 3-Module OVRWatch™ where Module 1, 1101, is the interface between the Internet or local router, etc., and Module 3, 1103. An optical link, 1104, is the physical conductor for data movements between Modules 1, 1101, and Module 3, 1103. Module 3, 1103, is interface between the user device, not shown, and Module 1, 1101. Module 2, 1102, controls the optical link, 104. Module 2, 1102, is not discoverable, as defined in U.S. Pat. No. 10,419,131. Modules 1 and 3, 1101 and 1103, respectively, are discoverable, as defined in U.S. Pat. No. 10,419,131.

FIG. 2 shows a block diagram of a 5-Module OVRWatch™ where Module 1, 201, is the interface between the Internet or local router, etc., and Module 3, 203. Module 3, 203, represents at least two computers, not explicitly shown, where one computer is used to handle normal communications, and the other computer is a shadow computer. An optical link, 206, is the physical conductor for data movements between Modules 1, 201, and Module 3, 203. Module 2, 202, controls the optical link, 206. Module 2, 202, is not discoverable, as defined in U.S. Pat. No. 10,419,131. Module 4, 204 controls the optical link, 207. Module 4, 204, is not discoverable, as defined in U.S. Pat. No. 10,419,131. Module 3, 203, is the interface between Module 1, 201, and Module 5, 205. An optical link, 207, is the physical conductor for data movements between Module 3, 203, and Module 5, 205.

In an alternative description of Module 3, 203, only has SC devices, thus only companion connections are allowed.

FIG. 3 shows a block diagram of a 7-Modules OVRWatch™ where Module 1, 301, is the interface between the Internet or local router, etc., and Module 3, 303. Module 3, 303, represents at least two computers, not explicitly shown, where one computer is used to handle normal communications, and the other computer is a shadow computer. Module 3, 303, shares the functions of hosting SC with Module 5, 305. An optical link, 308 is the physical conductor for data movements between Module 1, 301, and Module 3, 303. Module 2, 302, controls the optical link, 308. Module 2, 302, is not discoverable, as defined in U.S. Pat. No. 10,419,131. Module 4, 304, controls the optical link, 308. Module 4, 304, is not discoverable, as defined in U.S. Pat. No. 10,419,131. Module 3, 303, is the interface between Module 1, 301, and Module 5, 305. An optical link, 309, is the physical conductor for data movements between Module 3, 303, and Module 5, 305. Module 6, 306, controls the optical link, 310. Module 6, 306, is not discoverable as defined in U.S. Pat. No. 10,419,131. Module 5, 305, is the interface between Module 3, 303, and Module 7, 307. An optical link, 310 is the physical conductor for data movements between Module 5, 305, and Module 7, 307.

In an alternative description of Module 3, 303, only has SC devices, thus only companion connections are allowed.

In an alternative description of Module 5, 305, only has SC devices, thus only companion connections are allowed.

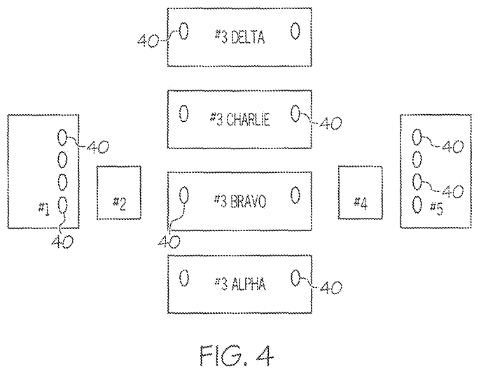

FIG. 4 shows the 5-Modules block diagram of FIG. 2 in greater detail. The ovals are photonic transceivers, items 40, shown sixteen (16) times. Module 1 is “internet-facing” and Module 5 is “protected system facing,” these Modules 1 and 5 computers are IoT known, discoverable, and accessible. Modules 2 and 4 are the “gate keeper” which are “invisible” as the IP addresses are not known, not discoverable, and not accessible, from any source. Module 3 has two classes of computers; class one is 3 Alpha which is IoT known, discoverable, and accessible, and the second class has three computers in this figure, 3 Bravo, 3 Charlie, and 3 Delta are discoverable, and not accessible from the IoT; SC. SC′ IP addresses are included in the header data field of an address associated with packetized data.

3 Bravo, 3 Charlie, and 3 Delta are discoverable, and accessible from other SC in other devices, via the Modules 2 and 4 White-List constructs.

FIG. 5 shows the 5-Modules block diagram of FIG. 4 in even greater detail.

The diagram shows the types of computers inside a system comprised of 5 modules; unknowable hidden computers (#2 and #4), discoverable but only accessible by identified companions shadow processes (B-F computers in Module 3), and known and discoverable and Internet accessible computers (#1, A, and #5).

If module 3 computer 3A were a SC then the whole of the 5 modules configuration is an Intranet, having normal communication with accessible computers.

Not shown in the drawing are the power isolation or port restrictions or the software. However, photonic signals are represented by items 112, 113, 114, and 115.

FIG. 5 is a high-level block diagram. Additional data lines between even-odd modules show how head data are used to determine the authorization and data transport between odd-odd modules.

Five modules are shown in FIG. 5. Modules 1, 2, 3,4, and 5, items 101, 102, 103, 104, and 105 respectively. Photonic signals are defined by items 112, 113, 114, and 115. Control signals are defined by items 106, 107, 108, 109, 110, and 111.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. An encryption system for securing data in motion comprising two or more computer systems with known, and unknown undiscoverable, Internet Protocol addresses for various computers in the computer systems at different locations wherein those known computers within the computer system are protected from being addressed except by each other, the protection to the known computers is defined by rules residing in adjacent unknown undiscoverable computers at each location providing decision-making about allowing or not allowing connectivity between the known computers in the different computer systems, these adjacent computers are not known to the Internet and are not addressable from any nodes on the Internet, the secure data occurs as encryption algorithms and encryption keys are applied to data in motion, encryption algorithms and encryption keys hosted to known computers with the computer systems.

2. An encryption system according to claim 1 wherein the encryption algorithms are hosted on a single computer within the computer system, and the keys related to the encryption algorithms are hosted a different computer within the computer system, and different levels of security derived from different algorithms can be on additional algorithms hosting computers within the computer system, and different levels of security derived from different keys can be on additional key hosting computers within the computer system.

3. An encryption system according to claim 2 having the relationships of levels of computers at one location are correlated to the same level of computers at a different location, wherein the locations are connected by public fibers and routing of the Internet, and only correlated levels are able to communicate with each other.

4. An encryption system comprising at least two devices communicating with an infrastructure of the Internet-of-Things (IoT), not all of the computers within said at least two devices are addressable from the IoT; a first device having some components within the IoT, communicating via the IoT infrastructure, with a second device having some components within the IoT, said first and second devices each has at least one IoT known and discoverable internal computers White Listed to each other, exclusively; additional devices' computers define the White Lists, said additional computers are invisible to the IoT.

5. An encryption system according to claim 4 wherein invisible is defined as unknown, not discoverable, and not addressable by the IoT.

6. An encryption system according to claim 4 where the two devices are shadow computers, known and discoverable White Listed computers from the Internet-of-Things, that are providing encryption and decryption services to the users of the Intranet via the IoT infrastructure.

7. An encryption system according to claim 4 wherein one device is further defined as a series of modules; module 1 host at least one known and discoverable and addressable computers representing the device's connectivity to the IoT; module 2 host an invisible computer, unknown, not discoverable, and not addressable, providing data flow control between a computer of module 1 and a computer of module 3; module 3 host at least one computer known, discoverable, and addressable, and modules 3 also host at least one shadow computer known, discoverable, and not accessible from the IoT computers, any module 3 shadow computer is capable of addressing other devices' module 3 shadow computers, encryption and decryption occurs in shadow computers; module 4 host an invisible computer, unknown, not discoverable, and not addressable computer providing data flow control between a computer of module 3, including a shadow computer, and a computer of module 5; module 5 host at least one known, discoverable, and addressable computer representing the device's connectivity to the user's systems.

8. An encryption system according to claim 7 wherein the shadow computers' encryption/decryption processes are further defined as database driven content for; algorithms, keys, and management of pointers to track usage of algorithms and keys; users can define unique mathematical constructs from any branch of mathematics with possible encryption value including but not limited to, algebra, geometry, calculus, topology, and multi-dimensional abstracts; said databases are updated by previously sent data in messages between shadow computers within devices operating as the Intranet using the IoT infrastructure.

9. An encryption system according to claim 8 wherein device-to-device addressability of computers not accessible from the IoT are White Listed and/or authenticated by additional computers in the device wherein said additional computers are unknown and not discoverable and not addressable computer, providing data flow control between the known and discoverable and not accessible computers in multiple devices, White Listing Internet Protocol addresses.

10. An encryption system according to claim 1 wherein the encryption system is configured with augmentations to allow users secure access to new encryption algorithms and keys over the Internet as White Listed companion isolatable computers communicate using one-time scripts of unknown keys applied to an equally unknown algorithms of keys and algorithms applied to a single message.

11. An encryption system according to claim 1 wherein even-numbered modules are gate keepers, controlling momentary connectivity between adjacent odd-numbered modules and wherein even-numbered modules are compared to data inspection rules of the odd-numbered modules.

12. An encryption system according to claim 1 wherein encryption occurs in module 3 (middle module) of a 5-module system.

13. An encryption system according to claim 1 wherein encryption occurs in modules three and five (paired middle modules) of a 7-module system.

14. An encryption system according to claim 1 wherein higher ordered systems (9-module or higher) have more computers in the middle modules.

15. A method of securing data in motion comprising the steps of using:
two or more computer systems with known, and unknown undiscoverable, Internet Protocol addresses for various computer in the computer systems at different locations wherein these known computers within the computer system are protected from being addressed except by each other;
the protection to the known computers uses rules residing in adjacent unknown undiscoverable computers at each location providing decision-making about allowing or not allowing connectivity between the known computers in the different computer systems;
the protection uses these adjacent computers that are not known to the Internet and are not addressable from any external nodes on the Internet;
the secure data occurs as encryption algorithms and encryption keys by applying data in motion, encryption algorithms and encryption keys hosted on known computers within the computer system.

16. The method of claim 15 includes:
the steps of hosting the encryption algorithms on a single computer within the computer system;
hosting the keys related to the encryption algorithms on a different computer within the computer system;
deriving different levels of security from algorithms on additional algorithms hosting computers within the computer system; and
deriving different levels of security from different keys on additional key hosting computers within the computer system.

17. The method of claim 15 further comprising the steps of:
correlating the relationships of levels of computers at one location to the same level of computers at a different location;
connecting by public fibers and routing of the Internet, wherein only correlated levels are able to communicate with each other.

18. The method of claim 15 further comprising the step of even-numbered modules controlling the address of the centered modules.

19. The method of claim 18 wherein the even-numbered modules prevent unwanted access to the addresses of the central modules.

20. The method of claim 15 wherein the step of bracketing encryption/decryption computers between unknown, not discoverable, and not addressable invisible computers creates a basis for a private Intranet encryption/decryption.
